(19) United States
(12) Patent Application Publication
(10) Pub. No.: US 2007/0015405 A1
(43) Pub. Date: Jan. 18, 2007

(54) Chip connector having inner and outer seats fitted with each other

(76) Inventor: Chou Hsuan Tsai, Hsin-Chuang City (TW)

Correspondence Address: PRO-TECHTOR INTERNATIONAL SERVICES, 20775 NORADA CT., SARATOGA, CA, 95070, US

(21) Appl. No.: 11/487,559

(22) Filed: Jul. 14, 2006

(30) Foreign Application Priority Data
Jul. 15, 2005 (TW) 094212060

(51) Int. Cl. H01R 13/73

(52) U.S. Cl. 439/571

(57) ABSTRACT

A chip connector includes an outer seat, an inner seat, terminals and an upper cover. The outer seat is formed with an opening. The inner seat has a top formed with a placement region in which a chip is placed. The placement region is formed with terminal slots inserted into the outer seat. The terminals are respectively disposed in the terminal slots. Each terminal has an elastic arm which can elastically move vertically and has a connection point to be electrically connected to a connection point of the chip. The upper cover presses down and positions the chip when being locked with the outer seat. The outer seat is formed with a positioning part, which is made of a metal material and downwardly projects over the bottom surface. The outer seat is positioned with and bonded to a circuit board through the positioning part.

### BACKGROUND OF THE INVENTION

1. Field of the Invention

The invention relates to an electrical connector, and more particularly to a chip connector having an inner seat and an outer seat fitted with each other.

2. Description of the Related Art

A chip (e.g., a CPU) has a bottom surface formed with a plurality of connection points. An electrical connector to be connected to the chip fixes the chip onto a base by a downward pressing force. Thus, the connection points of the chip and the terminals disposed in the terminal slots of the base are in elastic contact with each other and the electrical connections therebetween can be assured.

Referring to FIG. 1, a conventional chip connector includes an outer seat 10, an inner seat 20, an upper cover 14, a lever 16 and a plurality of terminals 25 (see FIGS. 2 and 3).

The outer seat 10 is made of metal and has two sidewalls 11 and a bottom surface 12. The middle of the bottom surface 12 is formed with an opening 13, and one of the sidewalls 11 is formed with a hook 101 extending outward.

One end of the upper cover 14 is pivoted to one end of the outer seat 10, and a flange 15 is formed at the middle of the other end.

The lever 16 has a first rod 17 and a second rod 18, which is pivoted to the other end of the outer seat 10 and formed with a curved portion 19.

The inner seat 20 is made of a plastic material and disposed in the outer seat 10 and is formed with a plurality of terminal slots 21. The top periphery of the inner seat 20 is formed with an upward flange 22 for surrounding a placement region 23 in which the chip can be placed.

As shown in FIGS. 2 and 3, the terminals 25 are respectively disposed in the terminal slots 21 of the inner seat 20. The terminal 25 has an elastic arm 26 formed with a projecting connection point 27 to be electrically connected to a connection point 91 on the bottom surface of the chip 90.

The chip may be fixed onto the above-mentioned structure. As shown in FIG. 4, the chip 90 is placed on the inner seat 20 and then the upper cover 14 is closed. As shown in FIG. 5, the lever 16 is rotated rightward to be pressed and positioned by the hook 101. As shown in FIG. 6, the curved portion 19 of the lever 16 presses and fixes the flange 15 of the upper cover 14 to provide a downward pressing force to press down the chip 90. At this time, as shown in FIG. 3, the connection point 27 of the terminal elastically presses against the connection point 91 of the chip to achieve the electrical connection effect.

The prior art structure has the following drawbacks. The chip connector is bonded to the circuit board through the pin of each terminal 25, and the outer seat 10 is not bonded and fixed to the circuit board and is only pressed by the inner seat 20. Thus, the lever 16 is positioned under the hook 101 of the outer seat 10 after the lever 16 has pressed and fixed the upper cover 14. That is, the reaction force of the downward pressing force is withstood by the outer seat 10, and the upper cover tends to lift up the outer seat 10 when the lever 16 is pressed down to the positioning state. Thus, the phenomenon influences the firmness of positioning the chip connector with the circuit board.

### SUMMARY OF THE INVENTION

It is therefore an object of the invention to provide a chip connector having an outer seat formed with at least one positioning part to be positioned with and bonded to a circuit board to enhance the firmness of positioning the chip connector with the circuit board.

To achieve the above-mentioned object, the invention provides a chip connector to be electrically connected to a chip having a plurality of connection points. The connector includes an outer seat, an inner seat, a plurality of terminals and an upper cover. The outer seat has a bottom surface and two sidewalls. A middle of the bottom surface is formed with an opening. The inner seat is made of a plastic material and has a top formed with a placement region in which the chip is placed. The placement region is formed with a plurality of terminal slots inserted into the outer seat and corresponding to the opening of the outer seat. The plurality of terminals is respectively disposed in the terminal slots of the inner seat. Each of the terminals has an elastic arm which can elastically move vertically and has a connection point to be electrically connected to the connection point of the chip. The upper cover presses down and positions the chip when being locked with the outer seat such that the connection points of the chip elastically contact the connection points of the terminals. The outer seat is formed with at least one positioning part, which is made of a metal material and downwardly projects over the bottom surface. The outer seat is positioned with and bonded to a circuit board through the at least one positioning part.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a pictorially exploded view showing a conventional chip connector.

FIG. 2 is a schematically cross-sectional view showing a state when the prior art chip connector is not connected to a chip.

FIG. 3 is a schematically cross-sectional view showing a state when the prior art chip connector is connected to the chip.

FIGS. 4 to 6 are pictorial views showing usage states of the prior art chip connector.

FIG. 7 is a pictorially exploded view showing a connector according to a first embodiment of the invention.

FIG. 8 is an assembled side view showing an inner seat, an outer seat and a positioning part according to the first embodiment of the invention.

FIG. 9 is a side view showing a usage state of the connector according to the first embodiment of the invention.

FIG. 10 is a pictorially exploded view showing an outer seat and a positioning part according to a second embodiment of the invention.

FIG. 11 is an assembled side view showing the inner seat, the outer seat and the positioning part according to the second embodiment of the invention.

FIG. 12 is a side view showing a usage state according to the second embodiment of the invention.

FIG. 13 is a pictorially exploded view showing an outer seat and a positioning part according to a third embodiment of the invention.

FIG. 14 is an assembled side view showing the inner seat, the outer seat and the positioning part according to the third embodiment of the invention.

FIG. 15 is a side view showing a usage state according to the third embodiment of the invention.

FIG. 16 is an assembled side view showing an inner seat, an outer seat and a positioning part according to a fourth embodiment of the invention.

FIG. 17 is a side view showing a usage state according to the fourth embodiment of the invention.

FIG. 18 is an assembled side view showing an inner seat, an outer seat and a positioning part according to a fifth embodiment of the invention.

FIG. 19 is a side view showing a usage state according to the fifth embodiment of the invention.

FIG. 20 is a pictorially exploded view showing a connector according to a sixth embodiment of the invention.

FIG. 21 is a pictorially assembled view showing the connector according to the sixth embodiment of the invention.

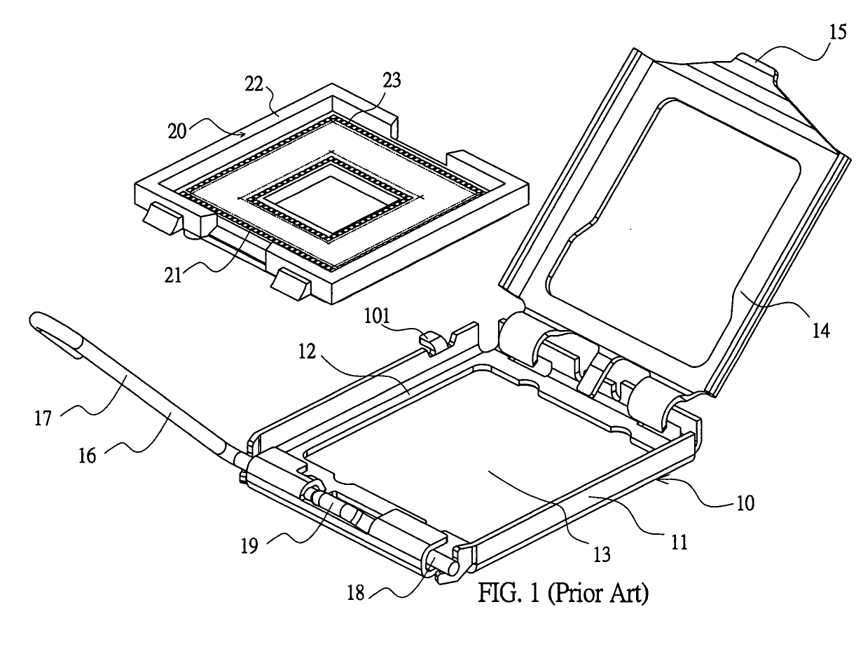

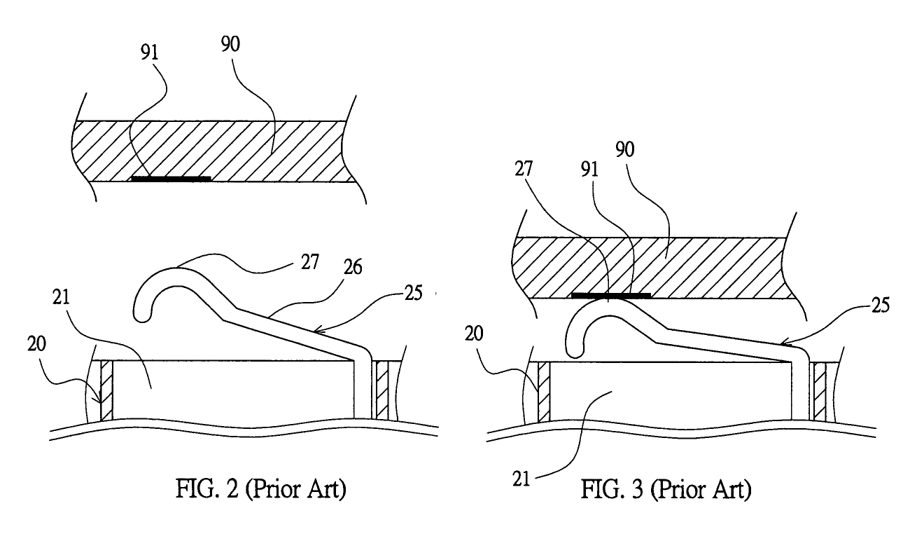

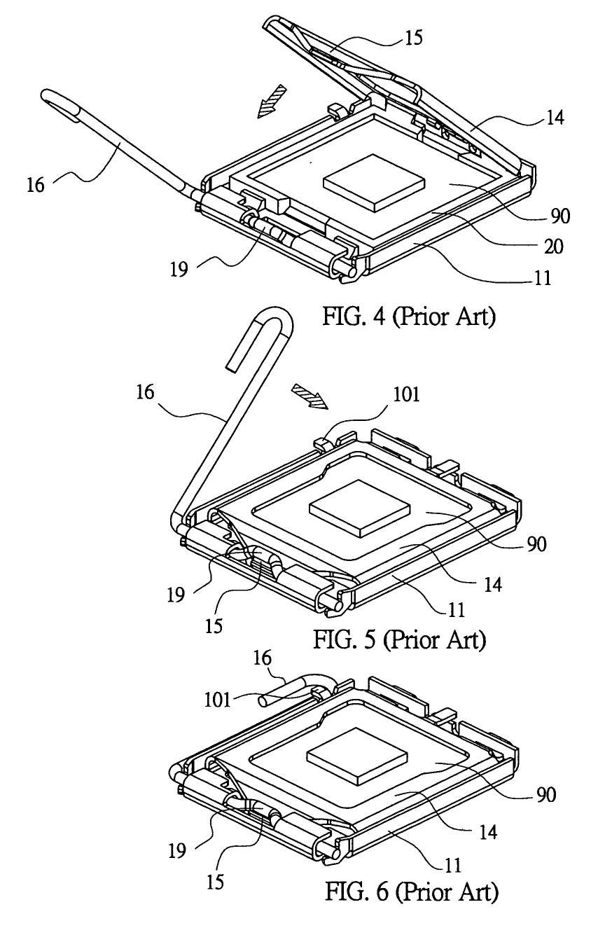

### DETAILED DESCRIPTION OF THE INVENTION

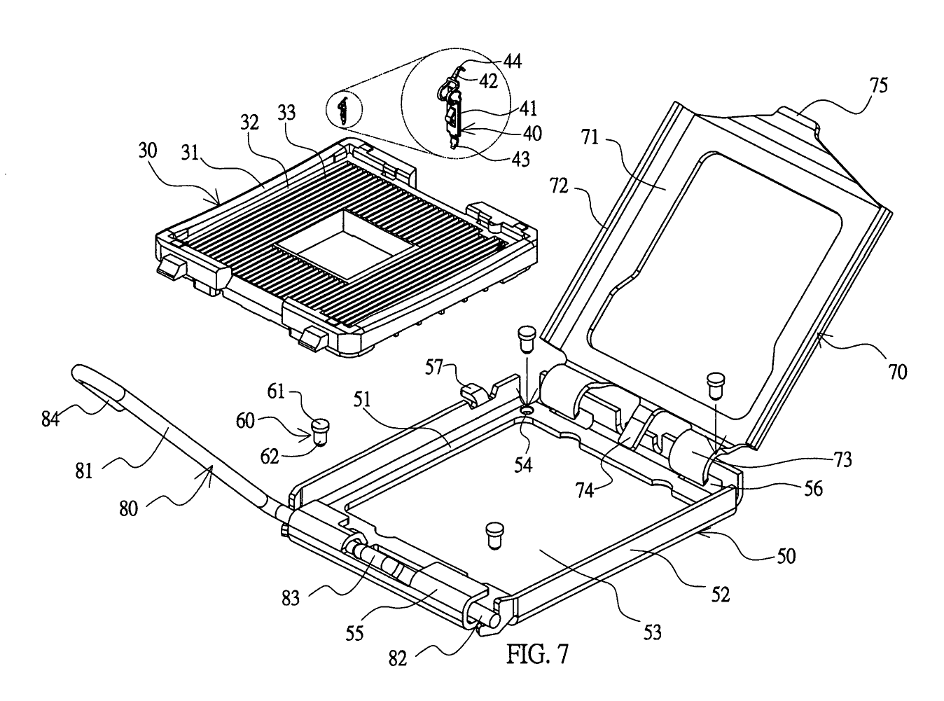

Referring to FIGS. 7 to 9, an electrical connector according to the first embodiment is to be electrically connected to a chip formed with connection points. The connector includes an inner seat 30, terminals 40, an outer seat 50, positioning parts 60, an upper cover 70 and a lever 80.

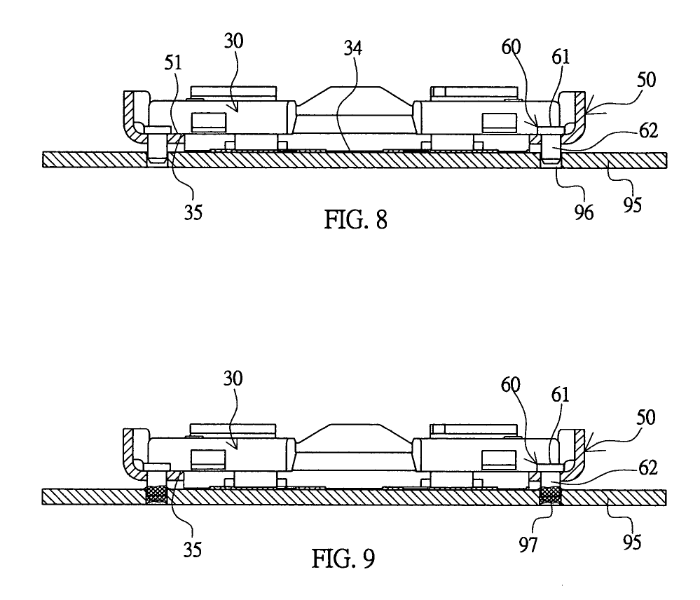

The inner seat 30 is made of a plastic material by way of injection molding. The top periphery of the inner seat 30 is formed with an upward flange 31 surrounding a placement region 32 of the chip. The placement region 32 is formed with a plurality of terminal slots 33. The bottom middle portion 34 of the placement region 32 is convex and the periphery of the placement region 32 is formed with a slot 35 (see FIG. 8).

The terminals 40 are respectively disposed in the terminal slots 33 of the inner seat 30. Each terminal 40 has a fixing portion 41, an elastic arm 42 and a pin portion 43. The fixing portion 41 tightly presses against the terminal slot 33. The elastic arm 42 is connected the bottom end of the fixing portion 41 and extends upward. The elastic arm 42 may elastically move and a projecting connection point 44 is formed near a tail end of the elastic arm 42. The pin portion 43 extends out of the terminal slot 33 and thus can be bonded onto a circuit board.

The outer seat 50 made of a metal material by way of pressing includes a bottom surface 51 and two sidewalls 52 for surrounding the inner seat 30. The middle of the bottom surface 51 is formed with an opening 53 corresponding to the placement region 32 of the inner seat 30. Four circular through holes 54 are formed at four corners of the bottom surface. In addition, the front and read ends of the outer seat are formed with pivoting portions 55 and 56. A hook 57 projecting outward is formed at one side of the rear end of the outer seat 50. The bottom middle portion 34 of the inner seat 30 passes through the opening 53. The slot 35 of the inner seat engages with the bottom surface 51 of the outer seat 50, and the inner seat 30 and the outer seat 50 are fixed together by way of high frequency welding.

The positioning part 60 is a rivet having a wider fixing portion 61 and a narrower bonding portion 62. The bonding portion 62 passes through the through hole 54 of the bottom surface of the outer seat 50 and projects over the bottom surface 51 and the inner seat 30, and is riveted into the through hole 54 through the fixing portion 61.

The upper cover 70 has a cover surface 71 and two sidewalls 72. Two sides of the rear end of the cover 70 are formed with arced pivoting portions 73. A stopper piece 74 is disposed at a middle of the rear end of the cover 70. The pivoting portion 73 is pivoted to a pivoting portion 56 at the rear end of the outer seat 50. The front end of the cover 70 is formed with a tab 75. The cover 70 presses down and positions the chip when the cover 70 is locked with the outer seat 50 such that the connection points of the chip are in elastic contact with the connection points of the terminals.

The lever 80 has a first rod 81 and a second rod 82 perpendicular to the first rod 81. The second rod 82 is pivoted to a pivoting portion 55 at the front end of the outer seat 50 and is bent into a convex rod 83. The outer end of the first rod 81 is bent into a handle 84. When the first rod 81 is rocked toward the rear end of the outer seat 50, the convex rod 83 can press the tab 75 of the upper cover 70. Thus, the upper cover 70 is locked and positioned with the outer seat 50, and the first rod 81 of the lever 80 is positioned under the hook 57 at one side of the outer seat 50.

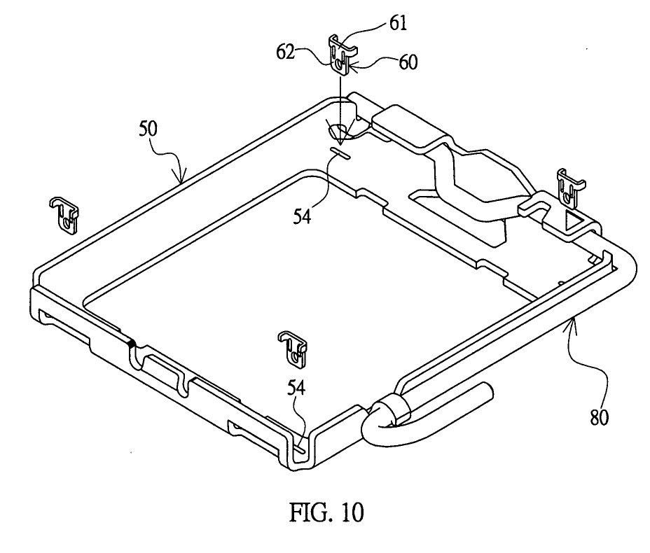

As shown in FIGS. 8 and 9, when the chip connector is bonded to a circuit board 95, the bonding portion 62 of the positioning part 60 on the outer seat 50 can be positioned with a bonding hole 96 of the circuit board 95, and be bonded and fixed to the circuit board 95 with the soldering paste 97.

Thus, the invention has the following advantages. When the chip connector is bonded onto the circuit board 95, the positioning part 60 of the outer seat 50 is also bonded to the circuit board 95. Thus, when the outer seat 50 withstands the reaction force generated when the upper cover 70 presses down the chip, the outer seat 50 cannot be moved upward and the firmness of bonding to the circuit board can be enhanced.

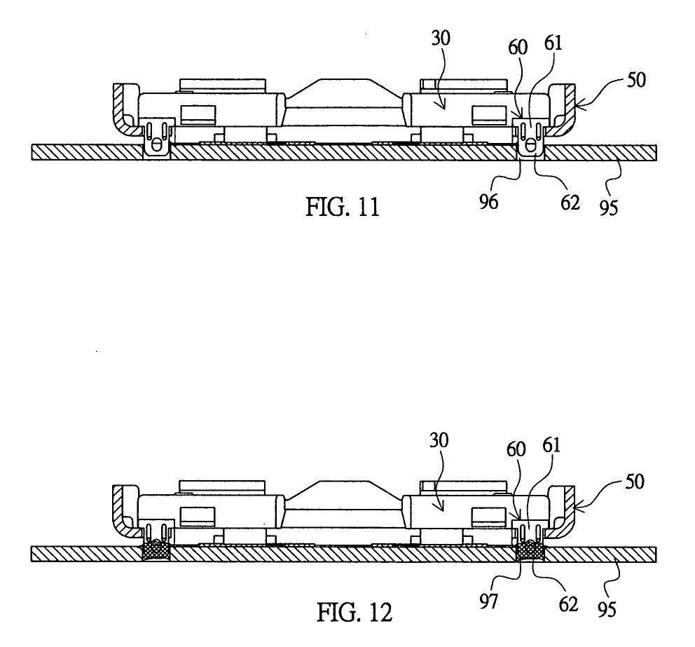

As shown in FIGS. 10 to 12, the second embodiment of the invention is almost the same as the first embodiment except that the positioning part 60 of the second embodiment has a fixing portion 61 and a bonding portion 62. The bonding portion 62 is a plate-like sheet. The bottom surface 51 of the outer seat 50 is correspondingly formed with a longitudinal through hole 54. The fixing portion 61 of the positioning part 60 is fixed into the through hole. The bonding portion 62 passes through the through hole 54 and projects over the bottom surface. When the chip connector is bonded onto the circuit board 95, the bonding portion 62 of the positioning part 60 on the outer seat 50 is positioned with the bonding hole 96 of the circuit board 95 and then bonded and fixed onto the circuit board 95 of the soldering paste 97.

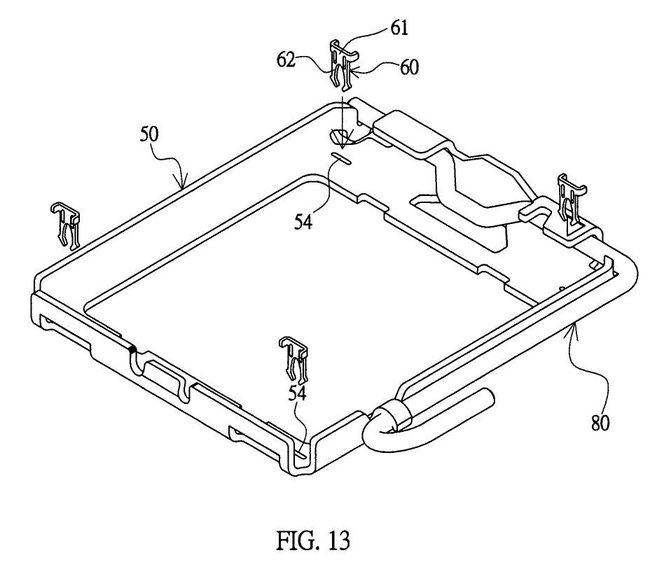

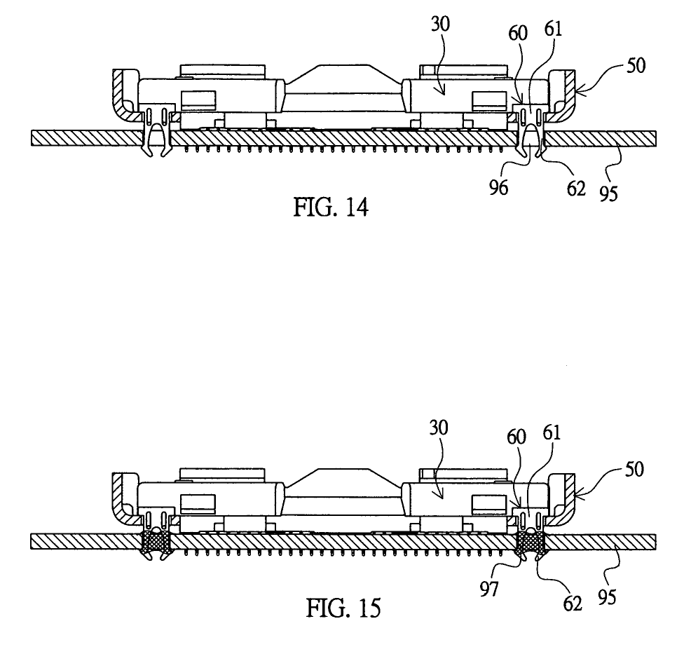

As shown in FIGS. 13 to 15, the third embodiment of the invention is almost the same as the second embodiment except that the positioning part 60 of the third embodiment has a fixing portion 61 and a bonding portion 62. The bonding portion 62 includes two elastic hooks spaced apart by a gap.

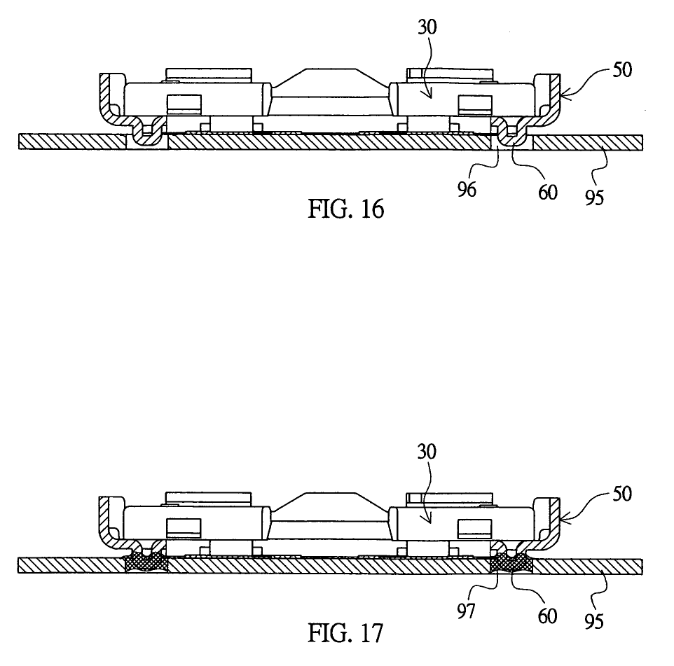

As shown in FIGS. 16 and 17, the fourth embodiment of the invention is almost the same as the first embodiment except that the positioning part 60 and the outer seat 50 in the fourth embodiment are integrally formed. That is, the four corners of the bottom surface 51 of the outer seat 50 are pressed down to form a projecting positioning part 60 projecting over the bottom surface 51.

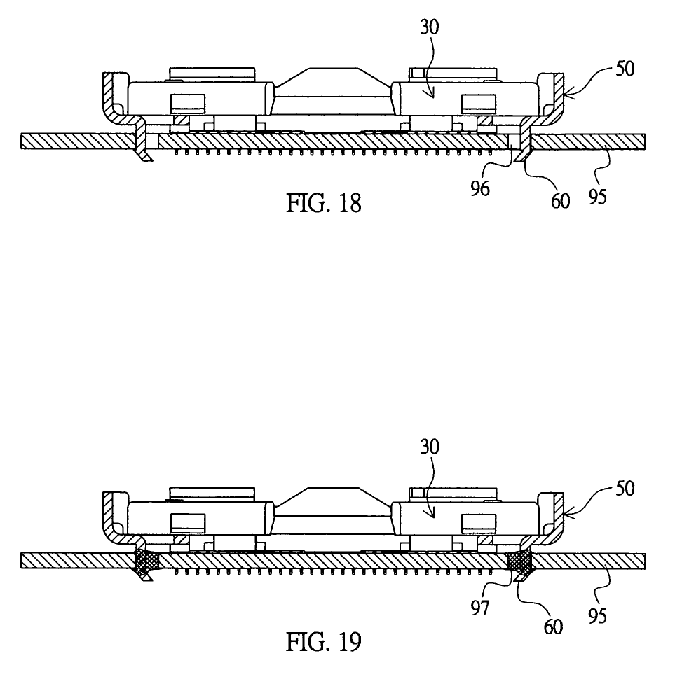

As shown in FIGS. 18 and 19, the fifth embodiment of the invention is almost the same as the first embodiment except that the positioning part 60 and the outer seat 50 in the fifth embodiment are integrally formed. That is, the four corners of the bottom surface 51 of the outer seat 50 are pressed down to form a projecting bottom surface 51 and prodded to form a positioning part 60 in the form of a hook.

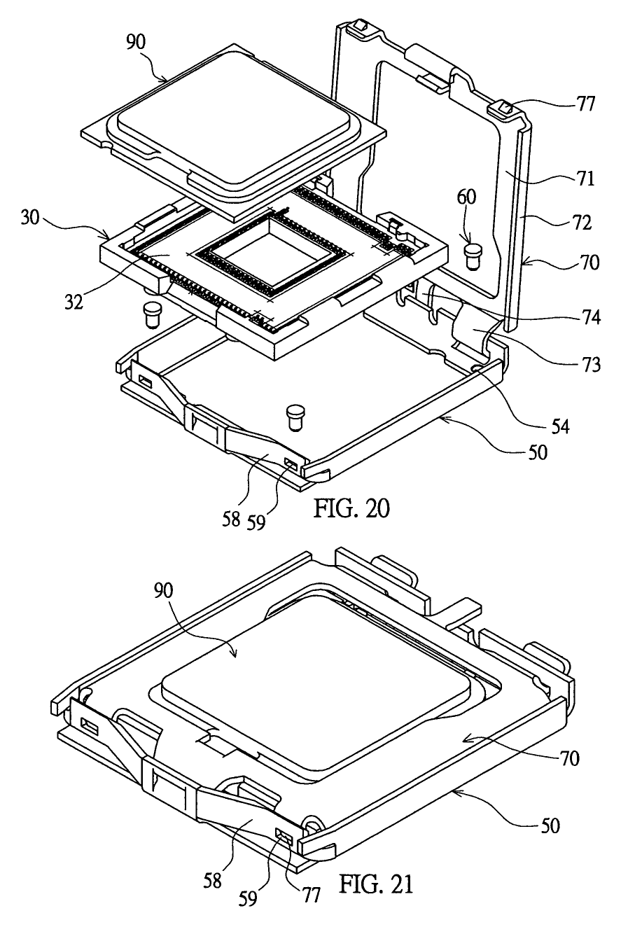

As shown in FIGS. 20 and 21, the sixth embodiment of the invention is almost the same as the first embodiment except that the upper cover 70 and the outer seat 50 of the sixth embodiment are locked in a manner different from that of the first embodiment. Two sides of the front end of the upper cover 70 are formed with locking portions 77. The locking portion 77 is a locking block. An elastic locking arm 58 extends from a middle of a front end of the outer seat 50 toward each of the two sidewalls 52. The distal end of the elastic locking arm 58 is formed with a locking portion 59 and exceeds by the sidewall 52. The locking portion 59 is a locking hole. When the upper cover 70 presses down the chip 90 placed in the placement region 32 and is closed onto the outer seat 50, the locking portion 77 of the upper cover 70 can be locked and positioned with the locking portion 59 of the outer seat 50.

In addition to the above-mentioned locking manner between the upper cover and the outer seat, the upper cover and the outer seat may also be locked in a sliding manner. That is, the upper cover locked with the outer seat can slide back and forth. The chip can be placed in when the upper cover slides to one side of the outer seat, and can be pressed and positioned when the upper cover slides to the middle of the outer seat.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A chip connector to be electrically connected to a chip having a plurality of connection points, the connector comprising:
an outer seat having a bottom surface and two sidewalls, a middle of the bottom surface being formed with an opening;
an inner seat, which is made of a plastic material and has a top formed with a placement region in which the chip is placed, wherein the placement region is formed with a plurality of terminal slots inserted into the outer seat and corresponding to the opening of the outer seat;
a plurality of terminals respectively disposed in the terminal slots of the inner seat, each of the terminals having an elastic arm which can elastically move vertically and has a connection point to be electrically connected to the connection point of the chip; and
an upper cover, which presses down and positions the chip when being locked with the outer seat such that the connection points of the chip elastically contact the connection points of the terminals,
wherein the outer seat is formed with at least one positioning part, which is made of a metal material and downwardly projects over the bottom surface, and the outer seat is positioned with and bonded to a circuit board through the at least one positioning part.

2. The chip connector according to claim 1, wherein a top periphery of the inner seat is formed with an upward flange surrounding the placement region.

3. The chip connector according to claim 1, wherein a rear end of the upper cover is pivoted to a rear end of the outer seat and the chip connector further comprises a lever, which has a first rod and a second rod perpendicular to the first rod, the second rod is pivoted to a front end of the outer seat and is bent into a convex rod, which presses and positions a front end of the upper cover when the first rod is rocked toward the rear end of the outer seat.

4. The chip connector according to claim 1, wherein the at least one positioning part is a rivet, the bottom surface of the outer seat is formed with at least one riveting hole, and the at least one positioning part rivets to the at least one riveting hole and extends out of the bottom surface of the outer seat.

5. The chip connector according to claim 1, wherein the at least one positioning part has a fixing portion and a bonding portion, the bottom surface of the outer seat has at least one through hole, the fixing portion of the at least one positioning part is fixed into the at least one through hole, and the bonding portion passes through the at least one through hole and projects over the bottom surface.

6. The chip connector according to claim 1, wherein the at least one positioning part has a fixing portion and a bonding portion, the bonding portion has two elastic hooks spaced apart by a gap, the bottom surface of the outer seat has at least one through hole, the fixing portion of the at least one positioning part is fixed into the at least one through hole, and the bonding portion passes through the at least one through hole and projects over the bottom surface.

7. The chip connector according to claim 1, wherein the outer seat is made of metal.

8. The chip connector according to claim 7, wherein the at least one positioning part and the outer seat are integrally formed.

9. The chip connector according to claim 1, wherein a front end of the upper cover is formed with at least one locking portion, a front end of the outer seat is formed with at least one elastic locking arm, a locking portion is formed near a distal end of the at least one elastic locking arm, and the locking portion of the upper cover may be locked and positioned with the locking portion of the outer seat when the upper cover presses down the chip disposed in the placement region and is closed onto the outer seat.

10. The chip connector according to claim 1, wherein a locking portion is formed on each of two sides of a front end of the upper cover, an elastic locking arm extends from a middle of a front end of the outer seat toward each of the two sidewalls, and a locking portion is formed near a distal end of the elastic locking arm.
